(19) United States
(12) Patent Application Publication
(10) Pub. No.: US 2014/0346184 A1
(43) Pub. Date: Nov. 27, 2014

(54) APPARATUS AND METHOD FOR DISPENSING MEDICATION

(71) Applicant: INFOPIA CO., LTD., Anyang-si (KR)

(72) Inventors: Byeong-Woo Bae, Anyang-si (KR); Keun-Young Kim, Seoul (KR); Seung-Min Ha, Gwangmyeong-si (KR)

(73) Assignee: INFOPIA CO., LTD., Anyang-si (KR)

(21) Appl. No.: 14/283,765

(22) Filed: May 21, 2014

(30) Foreign Application Priority Data
May 22, 2013 (KR) 10-2013-0057917
Nov. 28, 2013 (KR) 10-2013-0146631

(51) Int. Cl. A61J 7/00; B65D 83/04

(52) U.S. Cl. CPC A61J 7/0076; B65D 83/0409
USPC 221/1; 221/7

(57) ABSTRACT

An apparatus for dispensing medication is provided. The apparatus includes a case configured to comprise a medication packet container in which medication packets containing medications prescribed for a patient are seated, and a medication packet discharging opening through which the medication packets are externally discharged; a medication packet discharging component configured to discharge the medication packets from the medication packet container one by one; and a controller configured to control the medication packet discharging component to discharge the medication packets one by one from the medication packet container.

### CROSS-REFERENCE TO RELATED APPLICATION(S)

This application claims priority from Korean Patent Application Nos. 10-2013-0057917, filed on May 22, 2013, and 10-2013-0146631, filed on Nov. 28, 2013, in the Korean Intellectual Property Office, the disclosures of which are incorporated herein by references in its entirety.

### BACKGROUND

1. Field

The following description relates to an apparatus for dispensing medications, and more particularly, to a medication dispensing apparatus capable of storing medications prepared as per a doctor's prescription and automatically discharging one dose of a medication.

2. Description of the Related Art

A medication dispensing apparatus for administering correct amounts of medications to a patient is well known. Korean Patent No. 10-1171860 discloses a medication discharging apparatus which includes: a plurality of medication cases containing a correct amount of medications as one dose; a case storage unit in which the plurality of medication cases are loaded; a medication storage unit in which the case storage unit is detachably mounted; a driving assembly to provide a driving force to sequentially discharge the plurality of medication cases; a control box to apply or cut the power to the driving assembly; and an output unit, disposed in the control box, to output a warning message to advise a user to eject the medication cases after a predetermined period of time has elapsed. As such, the existing medication dispensing apparatus is capable of reminding of the administration time, and discharging the medication cases containing one dose of medications at the administration time. However, the aforementioned medication discharging apparatus requires a plurality of medication cases to contain a correct amount of medications for one dose administration, unavoidably requiring a larger size.

### RELATED ART DOCUMENTS

### Patent Application Documents

Korean Patent No. 10-1171860 (published on Dec. 28, 2011)

Korean Patent No. 10-0574084 (published on Jan. 11, 2006)

### SUMMARY

The following description relates to an apparatus for dispensing medications, which is capable of storing medications to be administered to a patient and automatically discharging medications at a predetermined administration time, while being reduced in size, and a method of dispensing medications of the apparatus.

In one general aspect, there is provided a medication dispensing apparatus including: a case configured to comprise a medication packet container in which medication packets containing medications prescribed for a patient are seated, and a medication packet discharging opening through which the medication packets are externally discharged; a discharging component configured to discharge the medication packets from the medication packet container one by one; and a controller configured to control the medication packet discharging component to discharge the medication packets one by one from the medication packet container.

The discharging component may include: a rotational supply component being rotatably supported by the case while being seated in the medication container, with the medication packets being wound around a center of the rotational supply component; and a medication conveying component configured to pull out the medication packets wound around the rotational supply component and externally discharge the medication packets through the medication packet discharging opening.

The case may include: a case body formed to allow the wound medication packets to be seated in the medication packet container through a top opening thereof; and a case cover coupled to the case body through a hinge, thereby being able to pivotally move upward and downward above the case body, resulting in the top opening of the case body being opened and closed, wherein the medication packet discharging opening is formed between the case cover and the case body.

The rotational supply component may include: a pair of rotating discs disposed to face each other on both sides of the wound medication packets, and being rotatably supported, respectively, by the rotation support within the case body and the case body itself; a supply shaft being securely fixed while penetrating centers of the pair of rotating discs such that the supply shaft can pass through a center of the wound medication packets, and being detached from a fixed position; and a knob formed on one end of the supply shaft in such a manner to be exposed to an outside of the case body.

The medication packet conveying component may include: a driving roller traversing the medication packet discharging opening and being rotatably supported by the case body such that the pulled medication packets can be seated on and carried by the driving roller; a rotation driving component configured to rotate the driving roller; a first passive roller rotatably supported by the case cover and disposed near one edge of the driving roller while the pulled medication packet is placed between the first passive roller and the driving roller; and a second passive roller being rotatably supported by the case cover, being disposed corresponding to a remaining area of the driving roller while the pulled medication packet is placed between the second passive roller and the driving roller, and having a shock absorber formed around a circumference thereof.

The discharging component may include a medication packet detection component to detect the pulled medication packets one by one.

The detecting component may include a light emitting element and a light receiving element which are vertically disposed to face each other at a distance and detect an identification mark on the pulled medication packet while allowing an edge of the medication packet to pass through a space therebetween.

The discharging component may include a discharging tray disposed within the case body such that the pulled medication packet is seated on and guided and supported by the discharging tray, and a guiding jaw disposed on the discharging tray and guiding the pulled medication packet while allowing an opposite edge of the medication packet to pass through a space between the discharging tray and the guiding jaw.

The discharging component may further include a packet cutter to cut the pulled medication packets one by one.

The medication dispensing apparatus may further include a communication component configured to communicate with an external patient management server, wherein the controller controls the discharging component to discharge the medication packet at a prescheduled administration time based on patient management information received from the patient management server.

The controller may control the discharging component to discharge the medication packet at the prescheduled administration time only when biometric authentication of the patient is successful.

The controller may generate an alarm to request the patient to obtain biometric data, based on the patient management information.

The controller may receive prescription data from the patient management server, match the received prescription data with biometric data of the patient, and manage matching results.

In another general aspect, there is provided a method of dispensing medications of a medication dispensing apparatus, the method including: pulling a medication packet out from a medication packet container wherein the medication packets are wound around a rotation support in a scroll manner; and externally discharging the pulled medication packets one by one.

The method may further include: receiving patient management information from a patient management server; and storing the receiving patient management information, wherein the discharging of the medication packets is performed at every administration time according to the stored patient management information.

The discharging of the medication packets may include generating an alarm to request a patient to obtain biometric data when the administration time as scheduled by the stored patient management information has arrived, and discharging the medication packet when biometric data of the patient is authenticated.

The discharging of the medication packets may include cutting the pulled medication packets one by one.

The discharging of the medication packets may include detecting a position at which the pulled medication packets are to be cut one by one; and cutting the medication packet at the detected position.

Other features and aspects will be apparent from the following detailed description, the drawings, and the claims.

### BRIEF DESCRIPTION OF THE DRAWINGS

FIG. 1 is a diagram illustrating a method of managing a medication of a patient according to an exemplary embodiment.

FIG. 2 is a block diagram illustrating a medication dispensing apparatus according to an exemplary embodiment.

FIG. 3 is a perspective view of a patient monitoring apparatus according to an exemplary embodiment.

FIG. 4 is a perspective view of the patient monitoring apparatus of FIG. 3 when a top opening of a case body is open.

FIG. 5 is an exploded perspective view of the patient monitoring apparatus of FIG. 3.

FIG. 6 is a perspective view to explain the operation of a medication packet conveying component of FIG. 3.

FIG. 7 is a block diagram illustrating a medication dispensing apparatus according another exemplary embodiment.

FIG. 8 is a perspective view of a medication dispensing apparatus according to an exemplary embodiment.

FIG. 9 is a diagram showing a schematic inner configuration of the medication dispensing apparatus of FIG. 8 as seen from a different point of view.

FIG. 10 is a diagram for explaining the process of discharging a medication packet by the medication dispensing apparatus of FIG. 8.

FIG. 11 is a diagram of another example of a medication packet unit of FIG. 8.

FIG. 12 is a flowchart illustrating a method of dispensing medication according to an exemplary embodiment.

FIG. 13 is a flowchart illustrating in detail operation 530 of FIG. 12.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

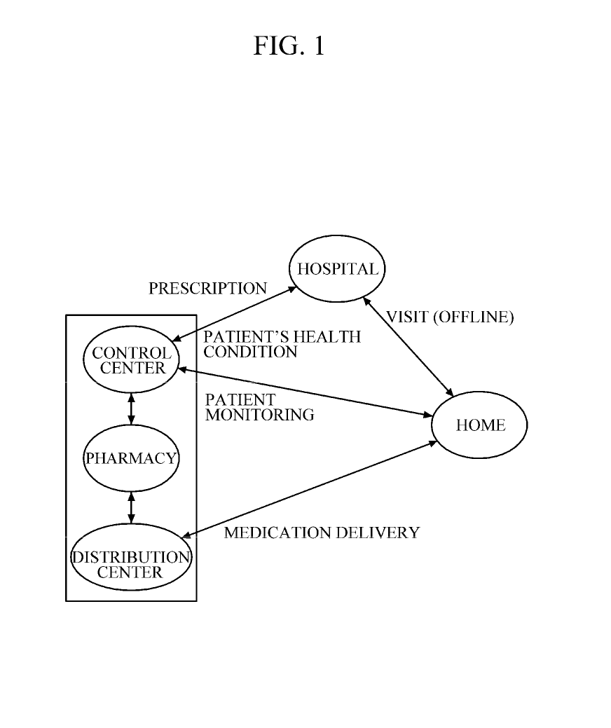

FIG. 1 is a diagram illustrating a method of managing a medication of a patient according to an exemplary embodiment. A physician examines a visiting patient, prescribes based on analysis of examination, and passes the prescription to a control center (Patient Management Server). The control center passes the received prescription to a pharmacy, and the pharmacy prepares medications according to the delivered prescription. When prepared using a medication packaging apparatus in the pharmacy, the prescribed medications are automatically packaged in individual packets on a per-dose basis. The pharmacy delivers the prescribed medications to a distribution center, and the distribution center ships the medications to the patient's home. Accordingly, the patient is able to receive the prescribed medications without having to visit the pharmacy. The patient or a patient's guardian receives the shipped medications, and manages them using a personal medication dispensing apparatus, which will be described below. The example illustrated in FIG. 1 is made under the assumption that the patient is cared at home, but the medication dispensing apparatus described below is not limited to at-home use, such that it may be used in hospitals, nursing homes, or the like.

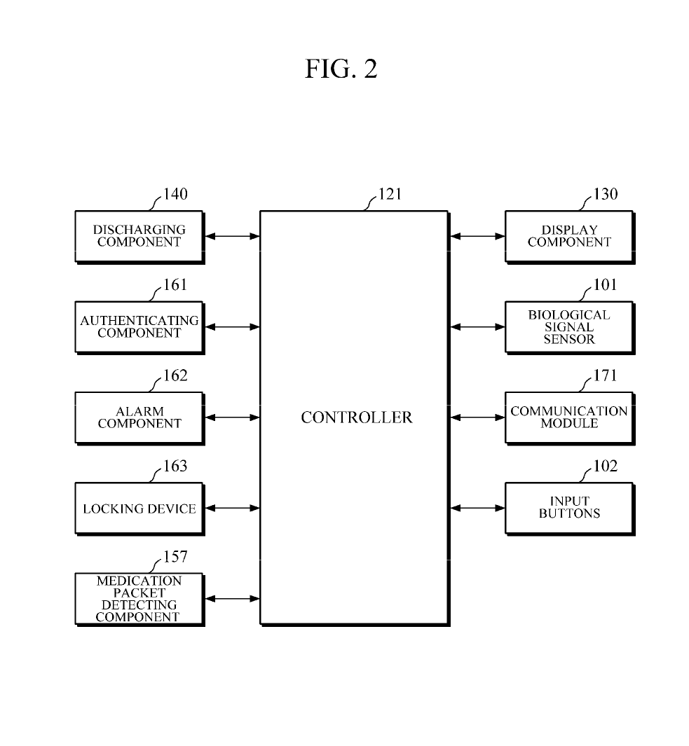

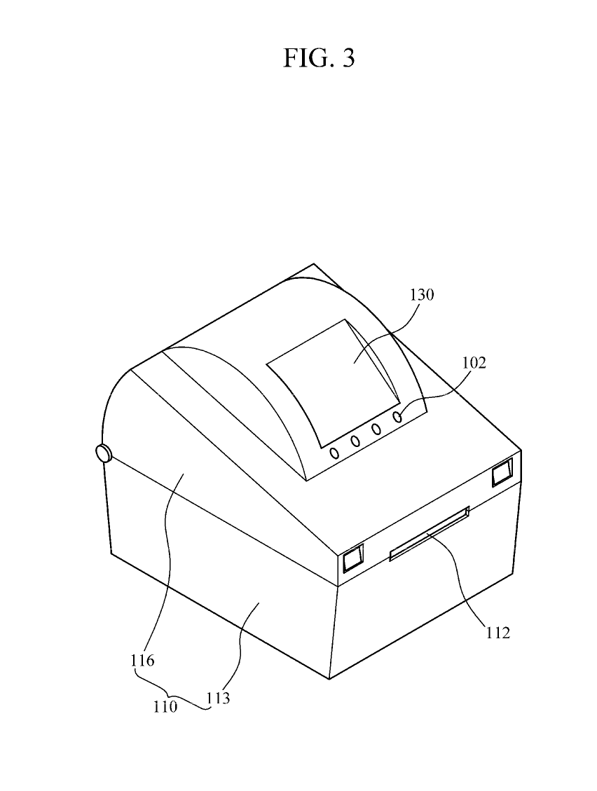

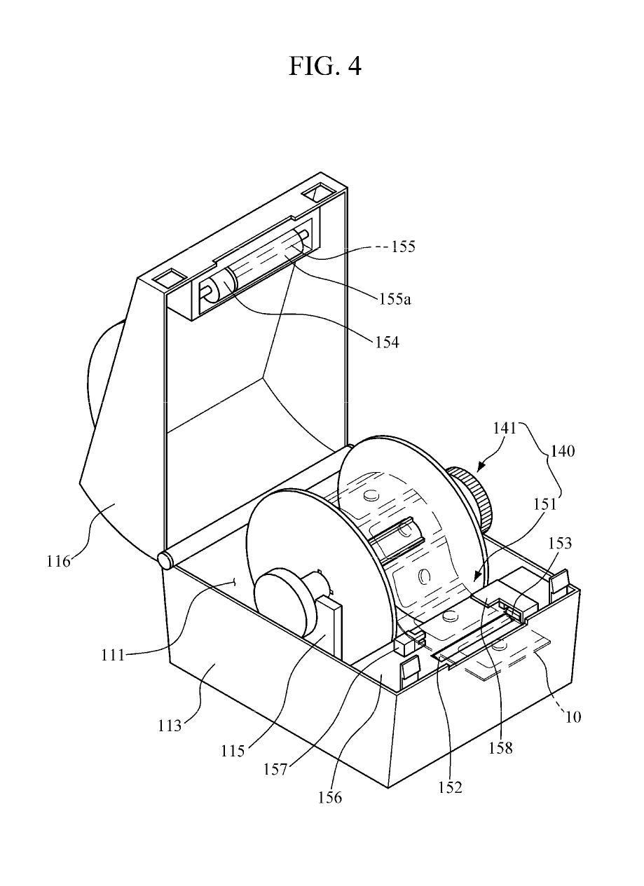

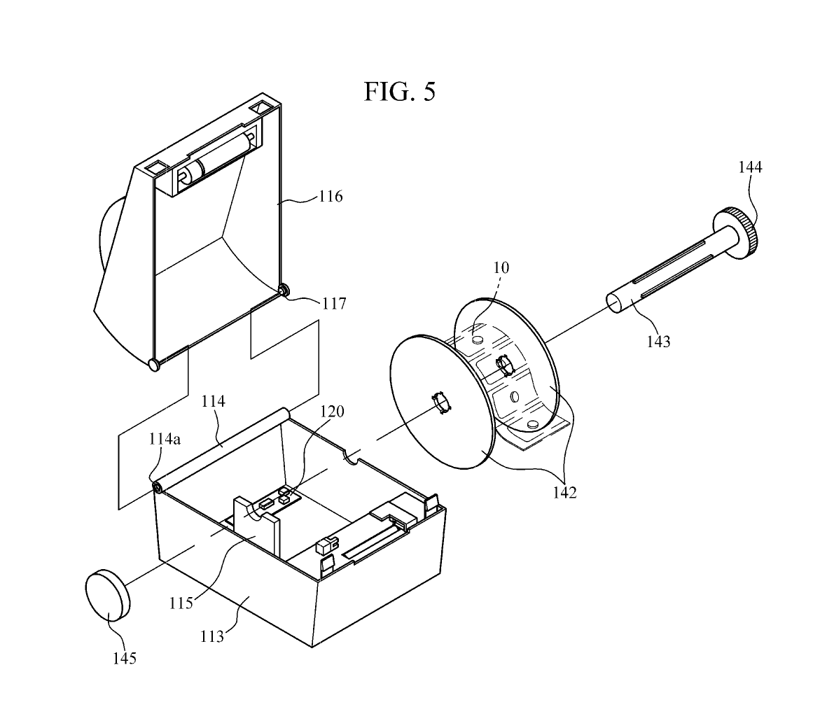

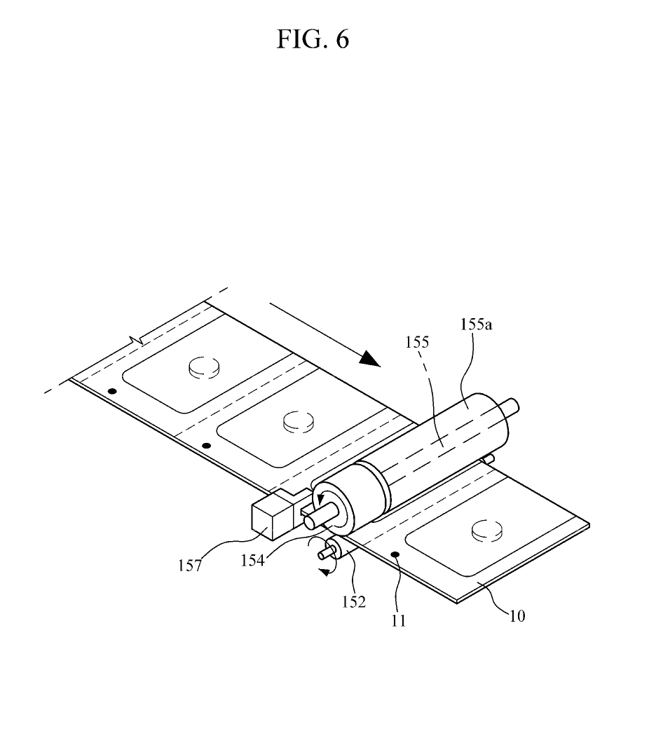

FIG. 2 is a block diagram illustrating a medication dispensing apparatus according to an exemplary embodiment. FIG. 3 is a perspective view of a patient monitoring apparatus according to an exemplary embodiment. FIG. 4 is a perspective view of the patient monitoring apparatus of FIG. 3 when a top opening of a case body is open. FIG. 5 is an exploded perspective view of the patient monitoring apparatus of FIG. 3. FIG. 6 is a perspective view to explain the operation of a medication packet conveying component of FIG. 3. Referring to FIGS. 2 to 6, the medication dispensing apparatus includes a case 110, a circuit board 120, a display component 130, and a discharging component 140.

The case 110 includes a medication packet storage space 111 to contain medication packets 10. The case 110 includes a medication packet discharging opening 112 at its front side, through which to eject the medication packets 10 out from the medication packet storage space 111. In this case, the medication packets 10 may be packaged in a series of unit-dose packages to be administered to a patient for the prescribed period of time. The medications are inserted into wrappers folded in a half-length, on a unit dose basis, and then the medications are sealed and successively packaged in unit dose form by sealing each wrapper. The medication packets 10 may have perforations or tear lines therebetween for easy tearing off. In addition, the medication packets 10 each may have a sealed edge along the longitudinal direction. The medication packets 10 may be wound in a scroll manner such that it can be accommodated in the medication packet storage space 111. The medication packets 10 may be wound around and supported by a roll member. In this case, the roll member may be inserted into and supported by a supply shaft 143 which will be described below.

In one example, the case 10 may include a case body 110 and a case cover 116. The case body 113 may have an inner space and an open top. The case body 113 allows the wound medication packets 10 to be accommodated in the medication packet storage space 111 through the open top. The case body 113 may have an accommodating portion on the side thereof to seat a sensor of a biological signal sensor 101.

The case cover 116 may include an inner space and an open bottom. The case cover 116 may be coupled to the case body 113 through a hinge, thereby being able to pivotally move up and down above the case body 113. The case cover 116 may allow the open top of the case body 113 to be opened and closed by pivot action. The case cover 116, which closes the open top of the case body 113, may confine the medication package storage space 111 between the case cover 116 and the case body 113.

The case cover 116 may be coupled to a rear upper side of the case body 113 through a hinge. The case body 113 may include a support block 114 at the rear upper edge. The support block 114 may have an insertion groove 114a at each end. The case cover 116 may have hinge shafts 117 on both ends of the rear lower edge. The hinge shafts 117 have forms insertable into the insertion groove 114a so that the hinge coupling between the case cover 116 and the case body 113 is possible. The case body 113 may have coupling pieces at the upper front end, while the case cover 116 may have coupling holes at the front lower end to allow the respective coupling pieces to be inserted therein. Accordingly, the case cover 116 is easily coupled to or uncoupled from the case body 113.

The medication packet discharging opening 112 may be disposed between the case cover 116 and the case body 113. The case cover 116 may have a cut or groove on the lower front leading edge to form an upper part of the medication packet discharging opening 112. The case body 113 may have a cut or groove on the upper front leading edge to form a lower part of the medication packet discharging opening 112.

The circuit board 120 is mounted in the case 110. The circuit board 120 may include a controller 121 to receive biological signals from the biological signal sensor 101 and process it. The biological signal sensor 101 measures biological signals of a patient. The biological signal sensor 101 may include at least one of: an electrocardiogram sensor, a non-invasive blood sensor, an oximeter sensor, or a blood glucose/cholesterol sensor, etc. Such sensors may be connected to an input/output port of the circuit board 120 via a connector. As a result, the sensors can measure biological signals, such as electrocardiogram, non-invasive blood pressure, oxygen saturation, blood glucose, and cholesterol of the patient, and provide them to the controller 121. In addition, the biological signal sensor 101 may include separate sensors to measure respiration, invasive blood pressure, end-tidal carbon dioxide (ETCO₂), body temperature, carbon monoxide, multi-gas, etc., an ultrasonic sensor, an electronic stethoscope, an automated external defibrillator (AED), and the like.

The controller 121 may output biological signal information to the display component 130 so that the display component 130 can display the information on a screen thereof. The controller 121 may transmit the biological signal information to a patient management server of the hospital or a nursing home. Accordingly, a physician or a nurse may be enabled to remotely monitor the patient's condition in real time through a monitor of the patient management server.

The controller 121 receives an instruction from a management server to discharge medication packets. In this case, the management server may be a patient management server of the hospital or the nursing home. If the patient obtains a prescription through a consultation with his/her physician and passes it to a pharmacy, the management server of the pharmacy may transmit to the controller 121 the instruction to discharge medication packets. In response to the instruction to discharge medication packets being transmitted from the management server to the controller 121 according to an administration schedule, the controller 121 outputs a discharge signal to the discharging component 140 so that the discharging component 140 can discharge at least one packet of medication packet 10 out of the apparatus. Accordingly, in a hospital, a nursing home, or private residence, the patient is conveniently provided with the medication packets 10 one by one at the exact time prescribed.

The circuit board 120 may include a LAN port for Internet connection with the management server. The circuit board 120 may include a power supply. The power supply may stably supply external power to the circuit board 120.

The display component 130 is mounted on the case 121 such that a screen is externally exposed. The display component 130 may be mounted on the upper part of the case cover 116. The display component 130 displays on the screen the biological signal information output from the controller 121. The display component 130 may consist of a liquid crystal display (LCD) panel, etc. The case cover 116 may include input buttons 102 to allow the user to input an instruction. The user's instruction received through the input buttons 102 may be input to the controller 121. One of the input buttons 102 may be an emergency call button.

The discharging component 140 is mounted in the case 110. The discharging component 140 externally discharges the medication packets 10 one by one from the medication packet storage space 111 through the medication packet discharging opening 112 in response to the discharge signal from the controller 121. The discharging component may include a rotational supply component 141 and the medication packet conveying component 151.

The rotational supply component 141 with the medication packets 10 wound around its center may be rotatably supported by the case 110, while being seated in the medication packet storage space 111. For example, the rotational supply component 141 may include a pair of rotating discs 142, the supply shaft 143, and a knob 144. The rotating discs 142 are disposed to face each other on both sides of the wound packets 10. One of the rotating discs 142 may be rotatably supported by the rotation support 115 within the case body 113, and the other disc may be supported by the case body 113. The rotation support 115 may protrude upward from an inner bottom surface of the case body 113. The rotation support 115 may have a seating groove in which the supply shaft 143 is seated, so that it can rotatably support one rotating disc 142. The case body 113 may also have a seating groove on the upper part so that it can rotatably support the other rotating disc 142.

The supply shaft 143 may be configured to be fixedly protruding through the center of each rotating disc 142, such that it can pass through the center of the roll of medication packets 10, or to be detached from the fixed position. The supply shaft 143 may pass through the center of one rotating disc 142 and then be inserted into the center of the other rotating disc 142, thereby being fixed. The supply shaft 143 may have projections at portions that are coupled to the rotating discs 142. The rotating discs 142 may have grooves into which the projections are fitted. As a result, the rotating discs 142 are able to rotate along with the rotation of the supply shaft 143. The knob 144 may be formed at one end of the supply shaft 143 in such a manner to be exposed to the outside of the case body 113. When the user grabs and rotates the knobs 144, the supply shaft 143 rotates along with the rotation of the knob 144.

The supply shaft 143 may pass through the rotating discs 142, and one end of the supply shaft 143 that protrudes from one rotating disc 142 may be securely fitted into a securing disc 145. The securing disc 145 may be spaced apart from the adjacent rotating disc 142, with the rotation support 115 disposed therebetween. Therefore, the supply shaft 143 may be seated in and rotatably supported by the seating groove of the rotation support 115 between the securing disc 145 and the adjacent rotating disc 142.

The medication packet conveying component 151 may unwind the wound medication packets 10 from the rotational supply component 141 and externally discharge the medication packets 10 through the medication packet discharging opening 112. For example, the medication packet conveying component 151 may include a driving roller 152, a rotational driving component 153, a first passive roller 154, and a second passive roller 155. The driving roller 152 may traverse the medication packet discharging opening 112 and be rotatably supported by the case body 113, such that the medication packets 10 from the rotational supply component 141 can be seated on and carried by the driving roller 152. The driving roller 152 may be formed of a rigid material. The driving roller 152 may be rotatably supported by a discharging tray within the case body 113. The discharging tray 156 may be disposed within the case body 113 such that the medication packets 10 that are pulled out from the rotational supply component 141 are seated on and guided by the discharging tray 156. The discharging tray 156 may include a shaft support in which both shaft ends of the driving roller 152 is so fitted as to be rotatably supported.

The rotational driving component 153 rotates the driving roller 152. The rotational driving component 153 may be controlled by the controller 121. The controller 121 may receive data about the length of one medication packet 10 in advance. The controller 121 may control the rotational driving component 153 to move the row of medication packets 10 the length of one packet, and thereby making it possible to discharge the medication packets 10 one by one out of the apparatus. The rotational driving component 153 may include a rotary motor. A driving axis of the rotary motor is concentrically coupled to one end of the driving roller 152 so that the driving roller 152 may rotate in unison with the rotation of the driving axis.

The first passive roller 154 is rotatably supported by the case cover 116. The first passive roller 154 is disposed near one edge of the driving roller 152 while the unwound medication packets 10 are placed between the passive roller 154 and the driving roller 152. Here, the first passive roller 154 may be disposed such that the sealed edge of the medication packets 10 is sandwiched between the first passive roller 154 and the driving roller 152. The first passive roller 154 may be formed of a rigid material or an elastic material. The first passive roller 154 may be disposed to press the sealed edge of the medication packets 10 to be in close contact with the driving roller 152. In response to the driving roller 152 rotating in a direction in which the medication packets 10 are discharged, the first passive roller 154 rotates in contact with the driving roller 152 such that the medication packets 10 can be externally discharged.

The second passive roller 155 is rotatably supported by the case cover 116. The second passive roller 155 may be concentrically coupled to and rotate together with the first passive roller 154. Outer shafts of the first passive roller 154 and the second passive roller 155 may be respectively fitted in shaft supports of the case cover 116. The second passive roller 155 may be disposed corresponding to a remaining area of the driving roller 152, with the unwound medication packet 10 interposed between the second roller 155 and the driving roller 152. In this case, the second passive roller 155 may be disposed in such a way that a medication containing portion of the medication packet 10 is interposed between the second passive roller 155 and the driving roller 152.

A shock absorber 155a may be formed around the circumference of the second passive roller 155. The shock absorber 155a may be made of sponge material. The second passive roller 155 may be disposed in such a manner that the shock absorber 155a is disposed to be in close contact with the medication containing portion of the medication packet 10. The second passive roller 155 may rotate in close contact with the medication containing portion of the medication packet 10 so that it may facilitate the discharge of the medication packets 10. In addition, while the medication containing portion of the medication packet 10 passes through between the second passive roller 155 and the driving roller 152, the shock absorber 155a of the second passive roller 155 may cushion the medication packet 10, thereby preventing the medications in the medication packet from being damaged.

Examples of the applications of the above-described medication dispensing apparatus are as follows: A patient in use of the medication dispensing apparatus prepares a row of medication packets 10, which are packaged in a series of unit-dose packages to be administered to the patient for a prescribed period of time, and then winds the medication packets 10 in a scroll manner. A pharmaceutical administrator separates the case cover 116 from the case body 113 to open the top of the case body 113.

Then, the pharmaceutical administrator places the wound medication packets 10 between the rotating discs 142 while separating the supply shaft 143 from the rotating discs 142. Then, the pharmaceutical administrator fits the supply shaft 143 into the rotating discs 142, and then secures the end of the supply shaft 143 protruding from one rotating disc 142 with the securing disc 145. Hence, the medication packets 10 are able to be supported by the supply shaft 143 placed in the center of a roll of the wound medication packets 10.

Then, the medication packets 10 supported by the supply shaft 143 and the rotating discs 142 are seated within the medication packet containing space 111. In this case, a leading edge of the medication packet 10 is dislocated from a set position of the medication packet conveying component 151, the pharmaceutical administrator may rotate the knob 144 to pull out the medication packets 10, and then align the leading edge of the medication packet 10 to the set position of the medication packet conveying component 151. Thereafter, the pharmaceutical administrator couples the case cover 116 to the case body 113 to close the top opening of the case body 113.

If an instruction is transmitted from the management server to the controller 121 to discharge a medication packet according to an administration schedule while the medication packets 10 are seated in the medication dispensing apparatus through such procedures, the controller 121 controls the medication packet conveying component 151 to externally discharge one packet of the medication packets 10. Then, the patient is able to be automatically provided with one packet of the medication packets 10 at the exact time prescribed.

The discharging component 140 may include a medication packet detecting component 157 that detects the medication packets 10 one by one. For example, the sealed edge of each medication packet 10 may have an identification mark 11. In a case where a wrapper of the medication packet 10 is made of a material that passes light therethrough, the identification mark 11 may be formed to prevent light from passing therethrough.

The medication detecting component 157 may include a light emitting element and a light receiving element. The light emitting element and the light receiving element are vertically disposed to face each other at a distance. The light emitting element and the light receiving element may detect the identification mark 11 of each packet while allowing the sealed edge of each medication packet 10 to pass through a space between the light emitting element and the light receiving element. When a part of the medication packet in which the identification mark 11 is not present enters between the light emitting element and the light receiving element, light emitted from the light emitting element enters into the light receiving element. When the identification mark 11 enters between the light emitting element and the light receiving element, the light emitted from the light emitting element cannot reach the light receiving element. Thus, the medication packet detecting component 157 may be able to detect the presence of the identification mark 11 according to whether light reaches the light receiving element.

Information obtained by the medication packet detecting component 157 may be provided to the controller 121. In response to a determination that the identification mark 11 is detected, the controller 121 may control the discharging component 140 to stop discharging the medication packet 10. Thus, it is possible to discharge the medication packets 10 exactly one by one. Meanwhile, a packet cutting component may be further provided to cut the medication packets 10 one by one in association with the medication packet detecting component 157.

The light emitting element and the light receiving element may guide the medication packets 10 while allowing the sealed edge of the medication packet 10 to pass therebetween. In this case, the discharging component 140 may include a guiding jaw 158 that guides the medication packet 10 while allowing the opposite edge of the medication packet 10 to pass therethrough. The guiding jaw 158 is disposed on the discharging tray 156. The guiding jaw 158 may be supported on the discharging tray 156 while being spaced apart from the discharging tray 156. Thus, the guiding jaw 158 is enabled to guide the medication packet 10 while allowing the opposite edge of the medication packet 10 to pass through a space between the guiding jaw 158 and the discharging tray 156.

The medication dispensing apparatus may include an authentication component 161. The authentication component 161 may perform a patient authentication at the time of discharging a medication packet, and, if the authentication is successful, it may enable the controller 121 to control the discharging component 140 to discharge the medication packet 10. For example, in response to an instruction from the management server to the controller 121 to discharge a medication packet according to the administration schedule, the controller 121 controls the alarm component 162 to emit an alarm sound. In this case, if the authentication is successful when the user inputs authentication information through the authentication component 161, the controller 121 controls the discharging component 140 to externally discharge one packet of the medication packets 10. If the patient does not input the authentication information within a predetermined period of time after emission of the alarm sound, the controller 121 may emit the alarm sound again to remind the patient to input the authentication information. Hence, it is possible to administer the exact dosage of medication to the patient at the exact time prescribed.

The authentication component 161 may be a radio frequency identification (RFID) reader, a near field communication (NFC) reader, or the like. In this case, the patient may input the authentication information, such as RFID tag or NFC tag, to the authentication component 161. The authentication component 161 may also include, but is not limited to, a finger print recognition device.

The medication dispensing apparatus may include a locking device 163 to lock the case cover 116 to the case body 113. The locking device 163 may be locked or unlocked under the control of the controller 121. In this case, the authentication component 161 may perform pharmaceutical administrator authentication, and, if the authentication is successful, the controller 121 may unlock the locking device 163. Thus, only the authenticated pharmaceutical administrator is allowed to open the medication dispensing apparatus, enhancing the security of the apparatus. The locking device 163 may be any known locking device known for locking the case cover 116 to the case body.

The medication dispensing apparatus may include a communication module. The communication module 171 may allow the patient or a guardian in a sickroom to have a conversation with a patient's doctor or nurse at a station. For example, in response to the patient or the guardian pressing an emergency call button, the communication module 171 may be connected to a phone device at the station under the control of the controller 121. The communication module 171 may include a voice call module or a video call module. In the case of the video call module, the display component 130 may be used for the video call. Also, an additional display component may be included in the medication dispensing apparatus for the video call.

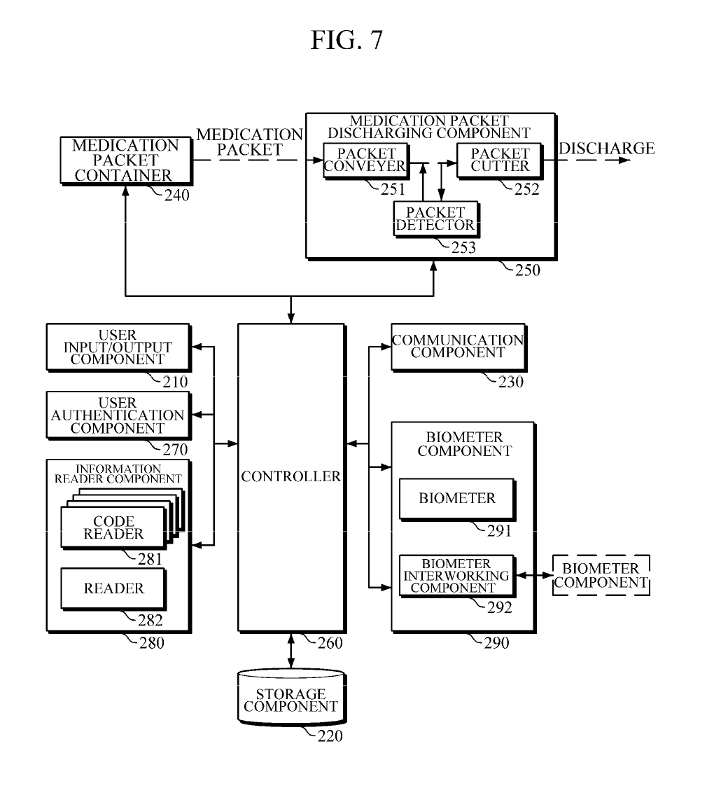

FIG. 7 is a block diagram illustrating a medication dispensing apparatus according another exemplary embodiment. Referring to FIG. 7, the medication dispensing apparatus includes a user input/output component 210, a storage component, a communication component 230, a medication packet container 240, a medication packet discharging component 250, and a controller 260. The user input/output component 210 includes a configuration for user input and a configuration for user output. For example, the user input/output component 210 may include, as an input element, multiple buttons for user's physical input and a touch pad for touch input, and may include, as an output element, a display module, such as an LCD, and an audio output module including, but not limited to, an amplifier and a speaker. In addition, the user input/output component 210 may include a touch screen that supports both user input and output. The storage component 220 is configured to include a non-volatile memory and to store a control program for medication management and relevant data used for control. The communication component 230, which is used to communicate with the patient management server, may be configured as a module for Internet network communication. However, aspects of the present disclosure are not limited thereto, such that the communication component 230 may be configured as, for example, an NFC module.

The medication packet container 240 contains delivered prescription medications. In one example, the medication packet container 240 contains medication packets in which medication is stored. The medication packet discharging component 250 discharges the medication packets from the medication packet container 240 on a per-dose basis. The medication discharging component 250 may include a packet conveyer 251 to carry the medication packets so that they can be externally discharged. The packet conveyer 251 may include a plurality of rollers. Further, the medication packet discharging component 250 may include at least one of a packet cutter 252 or a packet detector 253. The packet cutter 252 cuts the medication packets one by one. The packet cutter 252 may include a cutter guide to guide a cutter and its movement. The packet detector 253 detects the medication packets one by one. In one example, the packet detector 253 may be an optical sensor. To enable the optical sensor to detect the medication packets one by one, each medication packet may have a detectable mark printed thereon, which can be detected by the optical sensor. In one example, the detectable mark may be printed only on a trailing edge of the medication packet when seen in a direction of conveyance for discharge. Alternatively, the detectable mark may be printed on both the leading edge and the trailing edge of each medication packet.

The controller 260 is a controller for overall control of the medication dispensing apparatus, and uses the control program stored in the storage component 220 for the overall control. The controller 260 may control the medication packet discharging component 250 to discharge the medication packets from the medication container 240. To this end, the controller 260 may receive the patient management information from the patient management server, and may store the received information in the storage component 220, and control the dispensing of medication based on the stored patient management information. Here, the patient management information may include time information when the medication is administered to a patient according to prescription. For example, the patient management information may contain administration time information for administration to the patient, such as “30 minutes after a meal between 8 a.m. and 9 a.m.”, “30 minutes after a meal between 12 p.m. and 1 p.m.” and “30 minutes after a meal between 5 p.m. and 6 p.m.” In a case where the patient management information contains the administration time information, the controller 260 may enable a discharge of one dose of medications at 8 a.m., at 12 p.m., and at 5 p.m. In one example, the controller 260 may control the conveying component 260 to convey the medication packet upon the arrival of the administration time. Accordingly, the medication packet is conveyed and the packet detector 253 detects the printed mark. In response to detecting the printed mark, the controller 260 stops the packet conveyer 251 and controls the packet cutter 252 to operate a cutter. In so doing, one packet is externally discharged.

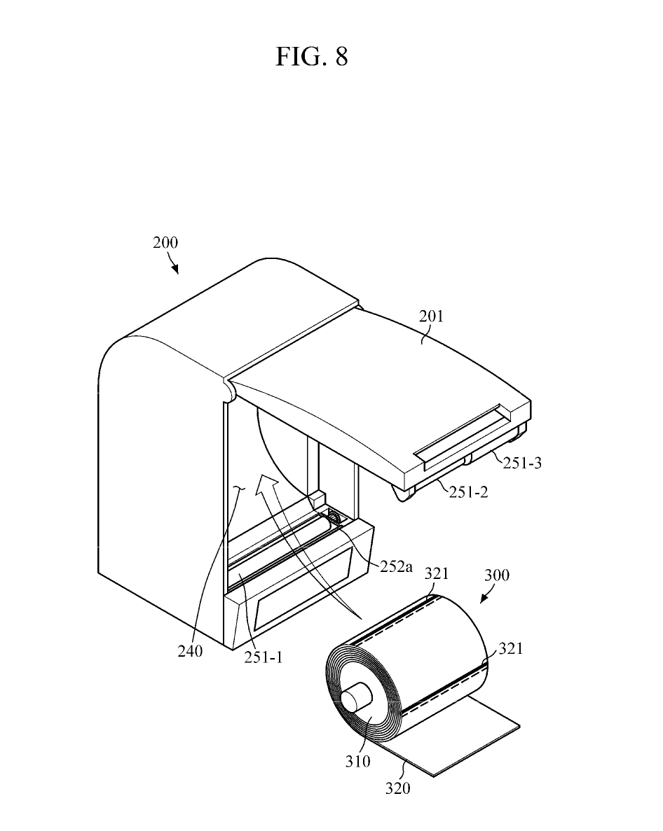

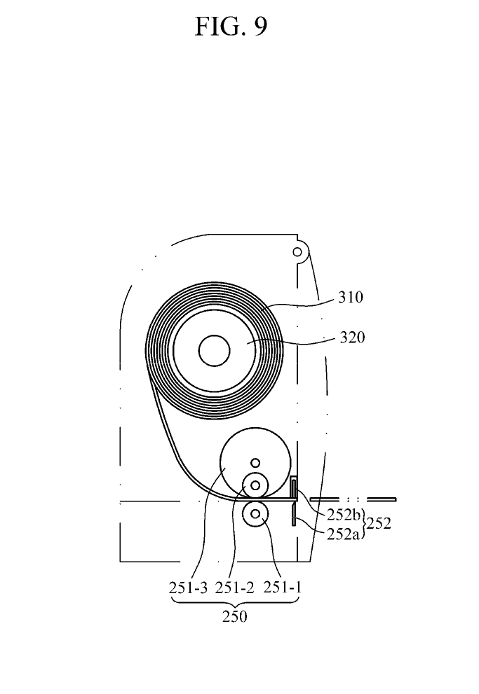

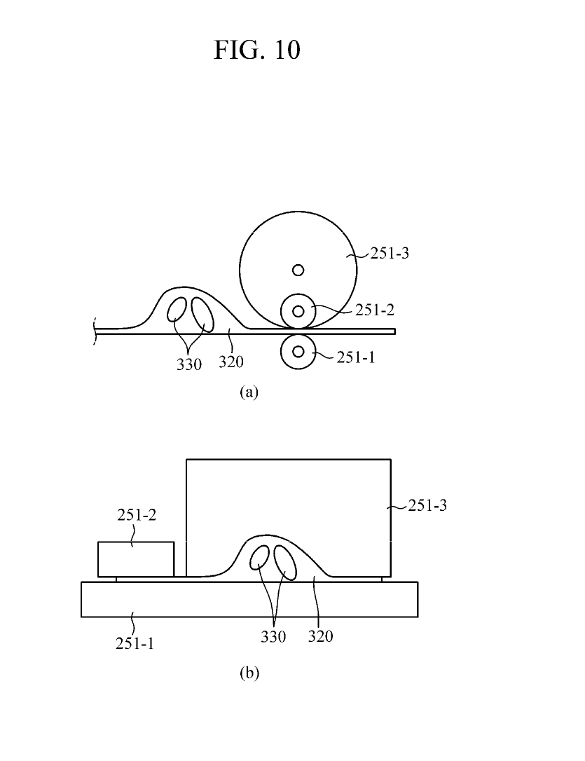

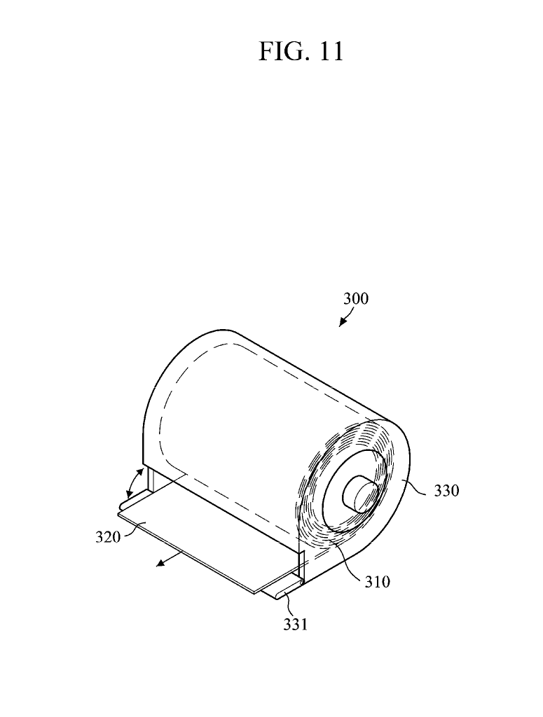

FIG. 8 is a perspective view of a medication dispensing apparatus according to an exemplary embodiment; FIG. 9 is a diagram showing a schematic inner configuration of the medication dispensing apparatus of FIG. 8 as seen from a different point of view; FIG. 10 is a diagram explaining the process of discharging a medication packet by the medication dispensing apparatus of FIG. 8; and FIG. 11 is a diagram of another example of a medication packet unit of FIG. 8. As shown in FIGS. 8 to 11, the medication dispensing apparatus includes a case 200 and a medication packet unit 300. In one example, the case 200 includes a discharging opening, a touch LCD, a fingerprint authenticator, an NFC reader, and the like, which are formed at the front, and further includes a cover 201 that covers a medication packet container 240. The cover 201 may be locked and unlocked by a locking device, which may switch between locking and unlocking positions according to user authentication by a user authentication component 270 or a user input through a user input/output component 210. Thus, only an authenticated user is allowed to open the cover 201 and deposit delivered prescription medications in the medication packet container 240. The medication packet unit 300 includes a roll 310 and a series of medication packets wound around the roll 310. Reference numeral 221 denotes the mark to be detected as described above.

The medication packet 300 may be delivered to a user. Alternatively, only the medication packets 320 may be delivered to the user, and in this case, the user may manually wind the medication packets 320 around the roll 310 included in the medication dispensing apparatus. The roll 310 is detachable from the medication packet container 240, and when mounted in the medication packet container 240, it is rotatably supported by the case 200. The medications are packaged in the individual medication packets, each of which may contain one dose of different medications. Such packaged medications may be referred to as multi-dose.

The case 200 includes a first roller 251-1, a second roller 251-2, and a third roller 251-3 to convey the medication packets unwound from the roll 310. The first roller 251-1, the second roller 251-2, and the third roller 251-3 are configured to be included in the packet conveyer 251. In addition, the case 200 may further include a packet cutter 252, and also may further include a medication detector 253, although not illustrated in FIGS. 8 and 9. In one example, the first roller 251-1 is placed in the case 200, and the second and third rollers 251-2 and 251-3 are placed on the cover 201. When the medication packet unit 300 is mounted in the case 200 and the cover 201 is closed, the first medication packet unwound from the roll 310 is situated between the first and second rollers 251-1 251-2 and the third roller 251-3. The packet cutter 252 may include a cutter 252a and a cutter guide 252b, wherein the cutter 252a may be disposed in the case 200 and the cutter guide 252b may be formed on the cover 201 to guide the vertical movement of the cutter 252a. The cutter 252a may be disposed on the outer side of the first roller 251-1 and the cutter guide 252b may be disposed on the outer side of the second roller 251-2 so as to correspond to the position of the cutter 252a.

To externally discharge the medication packets 320, the controller 260 controls a driving motor of the first roller 251-1 to rotate the first roller 251-1. In unison with the rotation of the first roller 251-1, the second roller 251-2 and the third roller 251-2 rotate together, so that the medication packet situated between the first, second, and third rollers 251-1, 251-2, and 251-3 are moved to the outside of the apparatus. In this case, the second roller 251-2 with a relatively smaller size than the third roller 251-3 may be made of a material such as urethane, and catch the edge of the medication packet 320 while discharging it. The third roller 251-3 with a larger size than the second roller 251-2 may be made of a sponge-like material to protect medication 300 within the medication packet 320, and sweep a bulging part of the medication packet containing the medication 300 to move forward. The controller 260 controls the cutter 252a to cut one medication packet that is moved outward from the roll 310 around which the medication packets are wound. The medication detector 253 may be used for cutting, as described above. If the packet cutter 252 is not included in the case 200, the user may manually cut the medication packet. In this case, the medication packet detector 253 may be used to determine a time when the packet conveyer 251 stops transporting the medication packet.

The medication packet unit 300 may further include a case 330 that encloses the roll 310 around which the medication packets 320 are wound, as shown in FIG. 11. The case 330 may include a discharging opening to discharge the medication packet 320 unwound from the roll 310, and an opening and closing member 331 to open and close the discharging opening. The medication packet unit 300 may be delivered with the opening and closing member 331 closed, and may be mounted in the case 200, with the opening and closing member 331 open for use. Accordingly, the medication packets 320 can be prevented from being unexpectedly unwound from the roll 310.

Each medication packet may contain only one medication. Such medication may be referred to as unit dose. In the case of a unit dose system, there may be multiple medication units 300, and the multiple medication units 300 may be mounted in parallel in the case 200. Therefore, in this case, the medication dispensing apparatus may be of a larger size than the medication dispensing apparatus shown in FIG. 8. In addition, there may be a plurality of medication packet discharging components 250. The controller 260 may control to operate only the first roller 251-1 and the cutter 252a corresponding to the medication packet to be discharged. Since medications to be administered to a patient at each administration time may vary during a day, there may be a case where only some medication packets are discharged from some rolls 310 without all medication packets having to be discharged from all rolls 310. To this end, the controller 260 may obtain prescription data from a server, and drive relevant first rollers 251-1 to discharge the medication packets to be administered at a current time, based on the obtained prescription data.

Moreover, in the case of unit-dose dispensing, the medication dispensing apparatus may further include an information reader component 280. The information reader component 280 may include multiple code readers 281. The code readers 281 are associated with the rolls 310, respectively. The code readers 281 reads unique code assigned to each medication packet wound around the roll 310, i.e., medication within the medication packet. The code reader may be a well-known tag reader. The unique code may be formed on each roll 310 or the medication packets wound around the roll 310. In the latter case, all medication packets wound around the roll 310 may have the same unique code thereon, or a medication packet to be firstly unwound may only have the unique code thereon. In the case where the unique code is formed only on the first medication packet, the first medication packet may contain no medication and be only used for code authentication. The controller 260 distinguishes medication packets of different rolls 310 from one another based on the unique code read by the code readers 28, identifies a medication to be administered at each administration time based on the prescription data, and rotates the corresponding roll to discharge the medication according to the identified prescription data.

In addition, the controller 260 may generate an alarm through the user input/output component 210 based on the patient management information. To this end, the patient management information may further contain additional alarm time information. In this case, the controller 260 generates an alarm based on the alarm time information. Alternatively, the controller 260 may generate an alarm based on the administration time information. The alarm output from the user input/output component 210 may notify the discharge of a medication, remind the user to authenticate him- or herself prior to discharge of the medication, or indicate any other events.

In another example, the controller 260 may discharge one dose of medications at every predetermined time based on the patient management information only when user authentication is successful prior to the discharge of medications. That is, only an authenticated user is allowed to be provided with medications prescribed as one dose. To this end, the medication dispensing apparatus may further include a user authentication component 270. The user authentication component 270 may include one or more biometric authenticators to authenticate the user (patient). For example, the user authentication component 270 may include a fingerprint authentication module, an iris authentication module, a face authentication module including a camera, and the like. Alternatively, the user authentication component 270 may be configured to authenticate a tag possessed by the user.

In one example, the controller 260 discharges one dose of medications only when the user authentication through the user authentication component 270 is successful. Other procedures may precede the user authentication. For example, the user inputs an instruction to discharge medications through the user input/output component 210, and then the controller 260 outputs a user authentication request message through the user input/output component 210. In response to the user authentication request message, the user takes necessary actions. In another example, the aforementioned procedures are not required. Instead, the controller 260 generates an alarm as the time to discharge the medications according to the patient management information arrives, wherein the alarm may contain a message to request for user authentication. In response to the alarm, the user takes necessary actions, and the controller 260 may execute a discharge of one dose of medication at a predetermined time only when the user authentication is successful. In another example, the medication dispensing apparatus does not include the user authentication component 270. In this case, the controller 260 discharges one dose of medication only when a password input by the user through the user input/output component 210 matches a preregistered password. That is, the user authentication can be executed using the password.

In another example, the controller 260 may enable storage of prescribed medications in the medication container 240 only when the user authentication is successful. The user authentication may be carried out through the user authentication component 270 or the user input/output component 210, as described above. In one example, the controller 260 may unlock the locking device of the cover 201 that covers the medication packet container 240, upon the success of user authentication, so as to open the cover 201. When the cover 201 is opened, the authenticated user puts the prescribed medications in the medication packet container 240 and then closes the cover 201. The locking device of the cover 201 that covers the medication packet container 240 again comes into a locking position. There may be preceding procedures: for example, in response to an instruction to accommodate medications being input by the user through the user input/output component 210, the controller may control the user input/output component 210 to output a user authentication request message through the user input/output component 210. In response to the user authentication request message, the user takes necessary actions for authentication. The cover 201 that covers the medication packet container 240 may be locked or unlocked by a key. As such, only an authenticated user is allowed to open or close the medication packet container 240, so that it is possible to securely store medications which require care in management.

In addition, the information reader component 280 of the medication dispensing apparatus may further include a reader 282. In one example, the reader 282 may be an RFID reader, an NFC reader, a scanner, or the like. The reader 282 reads identification information associated with the delivered prescribed medications. The identification information may be an identifier to recognize prescription or an identifier to recognize a patient. The identification information may be recorded in an RF tag or an NFC tag attached on a delivery packet. Alternatively, the identification information may be provided as 2-dimensional code or 3-dimensional code on the delivery packet. The controller 260 may determine whether the delivery packet is correctly delivered, based on the identification information read by the reader 282. For example, the identification information read by the reader 282 is compared to identification information previously stored in a storage component 220, and when the read identification information is identical with the stored identification information, it is determined that the delivery packet is successfully delivered.

The identification information previously stored in the storage component 220 may be provided from an external server (e.g., the control center shown in FIG. 1). When prescription is given, the server may automatically pass identification information to the medication dispensing apparatus. To this end, the server separately manages the medication dispensing apparatuses. The medication dispensing apparatus may directly request the server for new identification information and the server may issue a response to the request. The request and the response may be periodically issued, or may be issued on when the medication dispensing apparatus switches from inactive state to active state. The controller 260 may store identification information received through a communication component 230 in the storage component 220, and use the identification information to determine whether a delivery packet is correctly delivered.

In another example, the controller 260 may transmit biometric data of a patient to the server through the communication component 230. To this end, the medication dispensing apparatus may further include a biometer component 290. The biometer component 290 may include at least one biometer 291. In addition, the biometer component 290 may include a biometer interworking component 292 that interworks with at least one external biometer that exists separately from the medication dispensing apparatus. Alternatively, the biometer component 290 may include both the biometer 291 and the biometer interworking component 292. The biometer 291 may be, for example, a blood glucose meter, HbAlc meter, a cholesterol meter, a liver enzyme counter, a cardiovascular diagnostic device, a cancer diagnostic device, a real-time PCR, a molecular diagnostic device, an oximeter, an ECG sensor, a home endoscopy, or the like. In addition, the biometer interworking component 292 may be configured to operate in connection with the one or more biometers by establishing a wired or wireless communication channel with the biometer 291 to allow biometric data obtained by the biometers 291 to be delivered to the medication dispensing apparatus.

The biometric data obtained by the biometer 291 or the biometer interworking component 292 may be new data or a collection of biometric data accumulated so far. In this case, the controller 260 stores and manages the accumulated biometric data in the storage component 220, and transfers the accumulated biometric data to the server.

In the case where the medication dispensing apparatus includes the biometer component 290, the controller 260 may perform associated procedures based on the patient management information. The patient management information may further include additional information as well as the aforementioned administration management information, and the additional information may be alarm time information at which the patient is requested to obtain biometric data. The time to obtain the biometric data may be decided by the patient's physician, for example, within a predetermined period of time before or after administration of medication, and information about the predetermined period of time for acquiring biometric data is contained in the patient management information. The patient management information may be stored in the storage component 220, and may be delivered from the server. That is, the controller 260 obtains the patient management information from the server through the communication component 230, stores the information in the storage component 220, and checks the information about the predetermined period of time for acquiring biometric data. When the predetermined time as contained in the information has arrived, the controller 260 produces an alarm through the user input/output component 210 to request the user for the biometric data.

In another example, the medication dispensing apparatus provides a black box function related to prescriptions of a physician. More specifically, the controller 260 matches the biometric data and prescription data of the physician and stores resultant data in the storage component 220. The prescription data may be obtained from the server. That is, the controller 260 receives the prescription data through the communication component 230 from the server, then matches the prescription data with the biometric data and stores and manages the resultant information in the storage component 220. The biometric data may be a collection of accumulated biometric data. The stored information may be externally provided as evidentiary material for legal disputes, if any, over a physician's prescription.

Further, the medication dispensing apparatus may allow an interaction with the patient. For example, an audio alarm, a flash alarm, and the like may be possible through the user input/output component 210, and a voice/video service to guide the procedures that the user needs to carry out may be provided. In addition, the medication dispensing apparatus may be equipped with a camera to enable the user to have a video call with the user's physician.

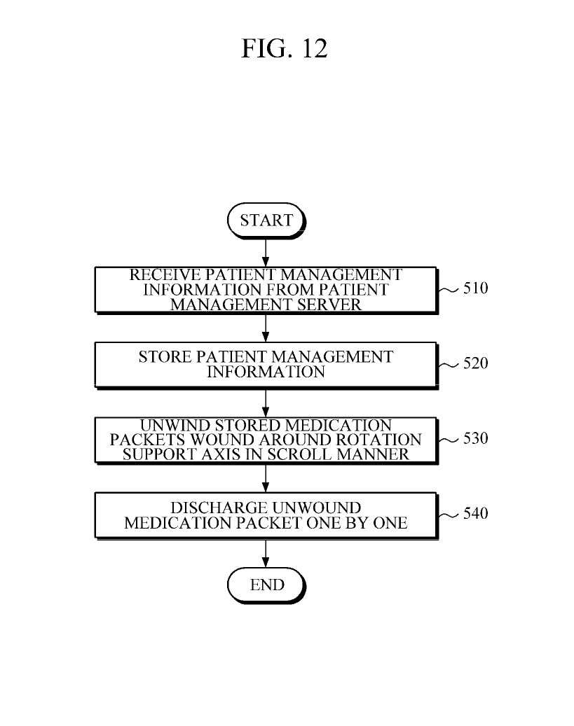

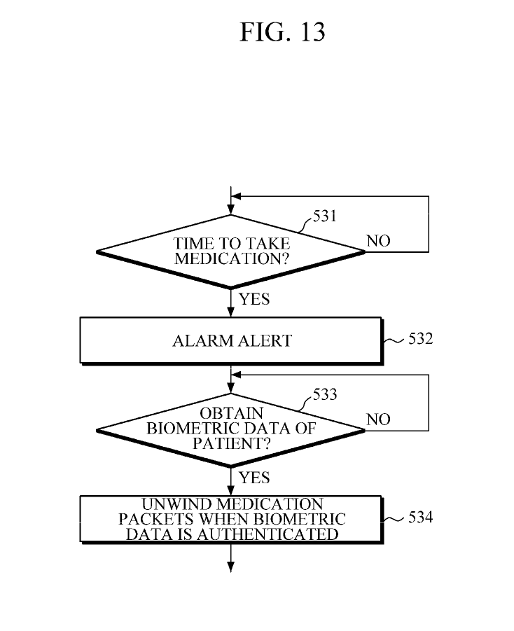

FIG. 12 is a flowchart illustrating a method of dispensing medication according to an exemplary embodiment and FIG. 13 is a flowchart illustrating in detail operation 530 of FIG. 12. A medication dispensing apparatus receives patient management information from a patient management server in 510, and stores the received information in a memory in 520. It is possible to omit operations 510 and 520. The medication dispensing apparatus pulls out stored medication packets wound around a rotation support in a scroll manner in 530, and externally discharge the medication packets one by one in 540. In operation 530, the medication dispensing apparatus may cut the medication packets one by one to discharge. In this case, the medication dispensing apparatus may detect a position at which to cut the medication packets one by one, and then cuts the medication packets at the detected position.

Referring to FIG. 13, in operation 530, the medication dispensing apparatus determines whether an administration time according to the patient management information has arrived in 531, and if so, produces an alarm to the patient in 532. In response to the alarm, the patient obtains biometric data in 533, after which the medication dispensing apparatus authenticates the biometric data achieved from the patient, and discharges the medication packet in 534 if the user authentication is successful.

As described above, according to the medication dispensing apparatus in accordance with the exemplary embodiments, a patient can store prescribed medications in the medication dispensing apparatus and the medication packets can be dispensed one by one at a prescribed time. Accordingly, the patient can be conveniently supplied with the prescribed medications in a hospital, a nursing home, or private residence. In addition, it is possible to easily manage medication administration for patients in a hospital, a clinic, a nursing home, and the like.

Moreover, the medication dispensing apparatus assists in the administration of medications to the patient, in conjunction with a server, so that it is possible to enhance the patient convenience. In addition, the medication dispensing apparatus contains the medication packets wound in a scroll manner, making it possible to achieve a compact medication dispensing apparatus.

Additionally, the medication dispensing apparatus allows only an authenticated user to deposit medications therein and to discharge the medication packets, and thus it is possible to ensure the safe administration and management of medications as prescribed.

The medication dispensing apparatus according to the exemplary embodiment ensures the correct delivery of prescribed medications.

Also, the medication dispensing apparatus transmits biometric data of the patient to the server, and hence the patient's physician who is authorized to access the server is enabled to remotely monitor the biological conditions of the patient, diagnose and give a prescription.

Furthermore, the medication dispensing apparatus according to the exemplary embodiment manages biometric data and a history of prescription data, which may be used as evidential material for any legal dispute.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A medication dispensing apparatus comprising:
a case configured to comprise a medication packet container in which medication packets containing medications prescribed for a patient are seated, and a medication packet discharging opening through which the medication packets are externally discharged;
a discharging component configured to discharge the medication packets from the medication packet container one by one; and
a controller configured to control the medication packet discharging component to discharge the medication packets one by one from the medication packet container.

2. The medication dispensing apparatus of claim 1, wherein the discharging component comprises:
a rotational supply component being rotatably supported by the case while being seated in the medication container, with the medication packets being wound around a center of the rotational supply component; and
a medication conveying component configured to pull out the medication packets wound around the rotational supply component and externally discharge the medication packets through the medication packet discharging opening.

3. The medication dispensing apparatus of claim 2, wherein the case comprises:
a case body formed to allow the wound medication packets to be seated in the medication packet container through a top opening thereof; and
a case cover coupled to the case body through a hinge, thereby being able to pivotally move upward and downward above the case body, resulting in the top opening of the case body being opened and closed, wherein the medication packet discharging opening is formed between the case cover and the case body.

4. The medication dispensing apparatus of claim 3, wherein the rotational supply component comprises:
a pair of rotating discs disposed to face each other on both sides of the wound medication packets, and being rotatably supported, respectively, by the rotation support within the case body and the case body itself;
a supply shaft being securely fixed while penetrating centers of the pair of rotating discs such that the supply shaft can pass through a center of the wound medication packets, and being detached from a fixed position; and
a knob formed on one end of the supply shaft in such a manner to be exposed to an outside of the case body.

5. The medication dispensing apparatus of claim 3, wherein the medication packet conveying component comprises:
a driving roller traversing the medication packet discharging opening and being rotatably supported by the case body such that the pulled medication packets can be seated on and carried by the driving roller;
a rotation driving component configured to rotate the driving roller;
a first passive roller rotatably supported by the case cover and disposed near one edge of the driving roller while the pulled medication packet is placed between the first passive roller and the driving roller; and
a second passive roller being rotatably supported by the case cover, being disposed corresponding to a remaining area of the driving roller while the pulled medication packet is placed between the second passive roller and the driving roller, and having a shock absorber formed around a circumference thereof.

6. The medication dispensing apparatus of claim 1, wherein the discharging component comprises a medication packet detection component to detect the pulled medication packets one by one.

7. The medication dispensing apparatus of claim 6, wherein the detecting component comprises a light emitting element and a light receiving element which are vertically disposed to face each other at a distance and detect an identification mark on the pulled medication packet while allowing an edge of the medication packet to pass through a space therebetween.

8. The medication dispensing apparatus of claim 7, wherein the discharging component comprises:
a discharging tray disposed within the case body such that the pulled medication packet is seated on and guided and supported by the discharging tray; and
a guiding jaw disposed on the discharging tray and guiding the pulled medication packet while allowing an opposite edge of the medication packet to pass through a space between the discharging tray and the guiding jaw.

9. The medication dispensing apparatus of claim 1, wherein the discharging component further comprises a packet cutter to cut the pulled medication packets one by one.

10. The medication dispensing apparatus of claim 2, further comprising:
a communication component configured to communicate with an external patient management server,
wherein the controller controls the discharging component to discharge the medication packet at a prescheduled administration time based on patient management information received from the patient management server.

11. The medication dispensing apparatus of claim 10, wherein the controller controls the discharging component to discharge the medication packet at the prescheduled administration time only when biometric authentication of the patient is successful.

12. The medication dispensing apparatus of claim 11, wherein the controller generates an alarm to request the patient to obtain biometric data, based on the patient management information.

13. The medication dispensing apparatus of claim 11, wherein the controller receives prescription data from the patient management server, matches the received prescription data with biometric data of the patient, and manages matching results.

14. A method of dispensing medications of a medication dispensing apparatus, the method comprising:
pulling a medication packet out from a medication packet container wherein the medication packets are wound around a rotation support in a scroll manner; and
externally discharging the pulled medication packets one by one.

15. The method of claim 14, further comprising:
receiving patient management information from a patient management server; and
storing the receiving patient management information,
wherein the discharging of the medication packets is performed at every administration time according to the stored patient management information.

16. The method of claim 15, wherein the discharging of the medication packets comprises:
generating an alarm to request a patient to obtain biometric data when the administration time as scheduled by the stored patient management information has arrived; and
discharging the medication packet when biometric data of the patient is authenticated.

17. The method of claim 14, wherein the discharging of the medication packets comprises cutting the pulled medication packets one by one.

18. The method of claim 17, wherein the discharging of the medication packets comprises:
detecting a position at which the pulled medication packets are to be cut one by one; and
cutting the medication packet at the detected position.
